(19) United States
(12) Patent Application Publication
(10) Pub. No.: US 2016/0092905 A1
(43) Pub. Date: Mar. 31, 2016

(54) SYSTEM AND METHOD FOR THE REGISTRATION, COMPENSATION, MANAGEMENT AND ANALYSIS OF PRODUCT OR CONTENT CUSTOMIZED PURCHASE OR SELLING

(71) Applicant: António ANDRADE, Sao Juliao do Tojal (PT)

(72) Inventor: António ANDRADE, Sao Juliao do Tojal (PT)

(21) Appl. No.: 14/870,034

(22) Filed: Sep. 30, 2015

Related U.S. Application Data
(63) Continuation-in-part of application No. 13/921,255, filed on Jun. 19, 2013, now abandoned.
Application No. 13/921,255 is a continuation-in-part of application No. 13/258,456, filed on Sep. 22, 2011, now abandoned.

(30) Foreign Application Priority Data
Mar. 24, 2009 (PT) 10410

(51) Int. Cl. G06Q 30/02; G06Q 50/00

(52) U.S. Cl. CPC G06Q 30/0234; G06Q 30/0236; G06Q 50/01; G06Q 30/0279

(57) ABSTRACT

The present invention refers to the customization of generic product and/or content purchase and/or offering, either comprising or not a social responsibility parameter by means of a system comprising the incorporation of a key, designated token, which solely identifies each item of said products. By means of an adequate incentive such as rendering a specific offer, the purchaser and/or recipient of the offer, will use this key to personally identify himself before the system, namely by means of a proper site on the Internet, through telephone line, SMS, MMS, WAP, among others. The present invention describes a system, database and co-related methods allowing the functionality. By means of this identification it is possible to convert generic product and/or content purchase and/or offering, either with or without a social responsibility parameter, into totally identified transactions, thus generating information and allowing its validation and promotion.

### RELATED APPLICATIONS

This application claims the priority under 35 U.S.C. 120 as a continuation in part of application Ser. No. 13/921,255 filed on Jun. 19, 2013 which is a continuation in part of Ser. No. 13/258,456 filed on Sep. 22, 2011 the disclosures of which are incorporated herein by reference.

### TECHNICAL DOMAIN OF THE INVENTION

The present invention refers to a method for the registration, compensation, management and analysis of product, gift or content customized purchase or selling, with or without a social responsibility parameter, run within an online and office ecosystem between Brands, People and Causes, by means of a unique identification of each item by means of a code and by means of managing the information obtained from said code.

### BACKGROUND OF THE INVENTION

### Needs of Brands, People and Causes in General:

Brands are facing an extremely competitive, mature and saturated market, full of complexities and barriers between themselves their clients, Causes, other industries and society in general, where the competition for the client's attention and preference is over the top.

People are facing fierce and intrusive consumer market where the competition by their attention and preference is extremely high consisting mainly of intrusive general communications and non-personalized offers. Their power his small, scarce compared with the Brands and other big institutions. They are powerless.

Causes are facing a society with non-mutual scarce resources, based in short-term ego People satisfaction and profitability based rational economic thinking for Brands.

The relationship between each one of these entities (Brands, People and Causes) is blind-sided, win-loss type (in order someone to win, someone has to loose) and unbalanced. The power of Brands over People and Causes is hugely disproportionate.

Brands, People and Causes have different interests, power relationships and timings.

Brands, People and Causes are either sparsely connected through individual connections in a non-competitive environment (e.g.: loyalty program between Brand and an individual person) or through third party non-synergic and public relationships (e.g.: Facebook, Instagram, etc.);

This kind of non-synergic and public third party relationship diminish the value Brands are able to generate with clients interactions, preference and behaviors; because Brands are not able to transform data in value or establish a relationship with their value chain and measure their productivity or to deal personally with their clients without putting in jeopardy their distribution channels.

This kind of non-synergic third party relationship also diminish the value People are able to gain with Brands in order give them their preference and attention, not only because the gain Brands are able to gain with clients data is limited but also because there is no open competition between Brands by their data, attention, attitude behavior and preference, according with the existing ecosystem.

Causes interact and communicate with Brands and People, using the same methods and channels as the Brands and have the same problems.

### Needs of Brands, People and Causes in Particular:

Brands are not able to seamless interact with their actual and potential clients (without being intrusive) and collect (data information: static pre-qualification, data traceability) and issue (communication information: dynamic) relevant information along their value chain (either internal or external) and sales cycle, with the right message and offer (personalized approach, without putting in jeopardy their sales channel), at the right time and moment (e.g.: buying, discovery or helping behavior).

Brands are not able to measure, in real time, its productivity and efficiency, in each one of its departments, its marketing investments either online, offline, above or below the line or human resources.

Brands do not really know their actual or potential clients, because People do not see any value in interacting and exchanging private information.

All the interactions happen through third parties which causes a market barrier between Brands and People.

Brands pay third parties (e.g.: Advertising in Televisions, Radio, Newspaper, Magazines, Internet Search Providers, Internet Social Networks, Webmaster and bloggers, etc. . . . ) to have the possibility to impact their actual and potential clients with targeted advertisement.

However Brands do not know individually know with whom they are communicating and are not able to collect individual information from each one of the People who were impacted with advertising, communications or offers.

This relevant information rests with the third party entity that which causes a market barrier between Brands and People.

Brands do not really know their actual or potential clients:
In terms of demographic Information (e.g.: Age, Sex, Birthday Date, City, etc.)
In terms of psychographic Information (scholarship, work status, work place, etc.)
In terms of relational information (e.g.: relationship status, family, friends, etc.)

Brands are not able to value each customer individually, according with their life span value, either by their:
Purchasing Behavior (e.g.: several purchasing decisions)
Social reach (e.g.: family and friends life time span purchasing value, e.g.: maximize the company share of wallet by client by combining family consumption)
Brand advocate value (Brand communication value around their family and friend, e.g.: social media company content sharing).

Brands do not really know when clients area searching for their products, buying or trying to help a Cause.

Brands guess, try, try-again and use third party entities who provide the channel, but do not give access to who was impacted with their message or offer.

Brands pay this kind of access by click (Cost per click), by visualization (Cost per 1.000 Visualization), GRP's (Gross Rating Points), etc.

To sum up, Brands are not able to communicate with their actual and potential clients, with personalized messages and offers, according with their individual value for the Company, at the exact time and moment, without being intrusive, because they don't really know their clients and are not able to guess at all time what is their behavior attitude in the sales funnel or life cycle, in order to target it.

People are beginning to have the notion of their power and know the money other Brands are winning with their daily attitudes, behaviors and means, either online, offline, above or below the line they normally use or are impacted.

People value their time, their attention, their privacy, they do not want anymore, that their private time, with friends, family or friends, be invaded with intrusive and general messages or offers by the Brands.

People are becoming day-by-day, more demanding, informed, autonomous, and rational and analytics, valuing their time; space and timings (decision process) being less and less open to general non-targeted, non-personal approach by Brands.

People want to separate their social life, from their consumer life, citizenship life, private life and professional life.

People are changing their purchasing behavior and becoming more and more rational and less emotional, consulting and checking all the offers and prices in the market using all the channels available, namely, internet, telephone contact, personal contact in different distributor and point of sales.

People are beginning to be more and more social and before making the final decision they check references and experiences with their social and professional network.

People have more and more difficulties in choosing the best option for their purchasing decision due to the fact that there are several different type of promotions in different sales channels with different prices and different offers, either from the same channel (upselling) or from different channels (cross selling).

People want more than life than just working, buying, friends or play, they also want to have a purpose and cause to give them a life meaning.

However, they have budget limitations, they have doubts about the real destination of his donations, the satisfaction they have is of short term and it is time consuming and hard to make donations.

Causes strive to survive in a material and depressed world, consumer oriented, overloaded with information about tragedies events, natural tragedies, misery and other worthy Causes, all trying to catch the People attention and help, with little success.

On the overall, we have worthy Causes competing by the People attention, preference and budget (share of wallet) with professional and well-funded Brands, helped by masters in marketing and psychological persuasion like the Madison Avenue best Advertising Agencies.

People gratification for helping is off short in time, seldom valued by society and the economic resources are scarce.

There is a doubt in contributor's minds, if the donation given reaches their goal, due to corruption and efficiency issues.

The act of giving donations is normally time consuming, detailed and leads People to forget and pass on to another more pleasure and immediate activity.

The message with which People are impacted is normally not positive, based on huge numbers and horrible pictures and People tend to close their eyes and hear and pass forward to another more pleasant activity and moods.

Also the figures are so big, that People normally tend to think that their possible effort is so small that their effect will be too small, and forget and go on with their life.

Causes have difficulty in passing their message and raise funds to fulfill their mission.

Causes do not have a consistent and a measurable argument to raise money together with Brands.

The more consistent one, should be the building of Brand goodwill in behalf of their customers or the fulfillment of legal obligations.

There is no rational economic argument for Brands to help Causes, misery, natural catastrophes, or others worth worthy Causes.

In economic though situations, has today, the available income People have is extremely small and People mostly channel the available income for their basic needs.

### STATE OF THE ART

US patent application US 2002/0188509 A1 (Fauziah) discloses a system for implementing a loyalty program on a network-wide level. The system associates UPC and SKU data on a network level to reward consumers and/or to analyze the data for a variety of business purposes, such as market segmentation analyses and/or analyses relating to consumer spending behaviors or patterns, for example.

US patent application US 2006/0036484 A1 (Voticky) discloses a method for distribution, allocation, redemption and recycling of bonus points that enable retailers, distributors and wholesalers to offer immediate awards to customers and each other. This method discloses: an award administration center that executes on a server; that a product offered for sale has a Universal Product Code (UPC) that uniquely identifies the product and a promotion code that uniquely identifies a promotion associated with the product, that the award administration center tracks the physical flow of the product and the information regarding distribution and sale of the product from manufacturer to ultimate consumer as well as use of the reward associated with the product along the distribution chain.

US patent application US 2001/0049624 A1 (Uyama) teaches systems and methods for profiling consumers, storing the profiles in a database, and targeting consumers with advertising according to their interests as reflected in the profiles. This advertisement distribution system includes, inter alia, a customer database storing profiles comprised of personal data of consumers that have expressed a desire to receive advertisements.

However, the systems and methods disclosed in US 2002/0188509 A1, US 2006/0036484 A1 and US 2001/0049624 A1, per se or in combination thereof, do not allow the tracking of purchases by actual or potential consumers throughout the value chain of the company without the need of collaboration of third parties, namely retailers or distributors.

The system and methods disclosed in said prior art documents do not enable Brands to establish a qualified, personalized, relevant bidirectional relationship with actual and potential clients, with pre-established rules and targeted advertising and promotional offers according to consumer real profile (CRP), consumer social profile (CSP) and consumer life time value (CLTV).

The system and methods disclosed in said prior art documents do not enable Brands to know in real time the return of investment in each marketing action, to measure the productivity of each department, division, business, distribution channels, partners and employees.

The system and methods disclosed in said prior art documents do not allow Brands to reward consumers with offline and online transactions in any part of the world without any middleware, software and internet connection.

The system and methods disclosed in said prior art documents do not enable consumers to make donations directed to the charity institution and activity of their choice and to track those donations.

### SUMMARY OF THE INVENTION

There is a need in a society (Brands, People and Causes) in crisis, depressed and with scare resources, dominated by money, ego and short term satisfaction, not only to distribute the financial and human resources in a better and fair way, but above all to find common interests and to create value by promoting synergies in win-win perspective and exchanging created value by adopting new paradigms in a safe, transparent online and offline ecosystem that assures rules compliance, competitiveness, balance of power and promotes a fair distribution, creating a better world with a significant change in People's life.

The objective of the invention is to create value (and a better world) among Brands, People and Causes, and such created value is based on the following seven steps.

1. The first step is to analyze the way society, People, Brands and Causes operate between each other's and methods used (as per the background of the invention).
Peoples Purchasing, Searching and Helping and society integration Paradigms.
Brands Management, Marketing and society integration Paradigms.
Causes Management, Marketing, Communication, Fund Raising and society integration Paradigms.

2. The second step is to find common interests in People, Brands and Causes.

People want privacy, personalization, target offers and communication vs Brands wants to interact, know their potential and actual clients real profile, know when clients are buying, searching or helping

People want to help, to have a purpose in life, know and interact with persons with the same interests vs Causes can give People this life meaning, gratification and social connections

People want to have purpose in life, to help without any effort, positive emotion, without financial investment, have social long term recognition vs Brands want to be relevant to People, know their actual and actual and potential clients vs Causes want to fund raise their activities and pass their message

3. The third step, is to see exactly what each one of the entities (Brands, People and Causes) can give or exchange with each other, and to create an online and offline ecosystem comprising Brands, People and Causes, where this created value is traded between all entities according with the best suited rules and methods to achieve maxim gain for all entities.

In this ecosystem Brands and Causes will issue a new currency that they will trade in the new market (e.g. like a stock exchange) with People: Interactive, Traceable and Sharable Data (ITS Data)

The new currency is ITS Data.

For the purposes of the invention, the ITS Data is issued by Brands and Causes and has the following features:

I—Interactive

In each interaction Brands collect valuable pre-qualified information and issue personalized dynamic communication, after contacting the central database, in order to see if the pre-qualified message will be changed or not.

T—Traceable

In each interaction Brands know exactly what was the financial investment, business areas and human resources allocated to achieve the actual or potential client redemption.

These allow Brands to integrate vertically and horizontally their internal and external value chain, have the information about their performance in real time, act immediately when needed, reward efficiency, and to measure everything. Everything is accountable.

S—Sharable

When the redemption or action occurs, the issuer (Brands and or Causes) receives with the consent of the receiver (People), the pre-qualification addressed to the ITC Data.

In order for Brands and Causes have access to this information (ITS Data) People have to allow it. This is crucial. And People will only do it, if the valued offer is considered sufficiently attractive according with their expectations and existing offers in the market (e.g.: Brands offers from other competitor).

Brands must be competitive and offer as much value has they can and they have to transfer step by step the value they gain to People and Causes they support.

The method of the invention refers in particular to the issuance and management of this ITS Data.

According to the method of the invention, ITS Data can be issued and offered by Brands to People, in the several touch points used by Brands to reach their actual and potential clients, namely in:
Company Products
Physical Offers
Interactions, with the offer of physical offer
Physical Content
Digital Content
TV, Radio or other above the line medium

Independently of the mediums used by Brands, Brands will only receive the ITS Data and achieve all the intended benefits if People redeem their offers.

This ITS Data is attached and qualified by Brands individually with physical or digital pixel (and or plug ins) to each product item or medium used in, when they are shipped or issued, immediately just before they are turned available to their actual and potential clients by designated Brands back offices, needed to make the operation.

Some practical examples Regarding Physical pixels:

1.1. Company product; Physical Offer; Interaction with Physical Offer; Content Offer, to be attached to physical medium (e.g.: pre-paid card with sequential variable code):

When the company physical products or offers are shipped to a specific point of sales, Promotion or Interaction opportunity the logistic Brands back office interacts with the marketing, information technologies and administration and makes the connection of:
The sequential identifier of each product
The variable unique offer
I—Information to collect, Information to issue
T—Total Investment, Number unique offers issued, Point of Sale, etc. . . .
S—Authorized Data Information Record

E.g.: The logistic department reads with a pistol bar reading the unique bar identifier of each individual product to ship, and attaches the range to the delivery note number, point of sales information, Promotion or Interaction opportunity and all pre-qualification made by the marketing back office to the corresponding offers.

1.2 Content Offer; Digital Content; Above the Line Content:

When these mediums are made available through specific media channel to potential and actual clients the marketing back office interacts with administration, sales channels, and information technologies and others defined by the company and make the connection of:
The sequential identifier of each content
The variable unique offer
I—Information to collect, Information to issue
T—Total Investment, Number unique offers issued, Point of Sale, etc. . . .
S—Authorized Data Information Record

The information to collect and issue, can be changed at any time according with new company goals or information received.

Example of information to issue: Value Offer, to redeem, Promotion Offers, and Personalized Message

Example of Information to collect: Point Sales Name, Medium Used, Demographic, Psychographic, or other relevant information for Brands.

4. The forth step is to assure that the online and offline ecosystem is an independent, competitive, transparent and safe environment with common agreed rules that allow People, Brands and Causes, with the changing of their methods and paradigms, to exchange the created value in order to achieve their common interests.

An ecosystem with no barriers where Brands, Causes and People, can implement their new paradigms and methods, through the exchange and negotiation of the ITS Data online, offline, bellow or above the line Data offers, ITS Data communications and ITS Data content (ITS Data).

5. The fifth step is to let People, Brands and Causes know that they can achieve their commons interest in an online and offline ecosystem, by adopting new paradigms and exchanging the created value (Communication, Engagement, and Experimentation).

6. The sixth step, is the general adoption of new attitudes, behaviors and paradigms.

ITS Data has value only if all entities in the market recognize it has a currency, want to use it and trade it.

In their daily life, People purchase, search and help according with the ecosystem paradigms, either online or offline.

In their strategic, tactic and daily decisions Brands organize their company and resources in order to achieve their goals, according with new management, marketing and social responsibility paradigms.

In their strategic, tactic and daily decisions Causes organize their company and resources in order to achieve their goals, fund raise their activity, communicate their message and interact with society according with new management, marketing and social responsibility paradigms.

7. The seventh step is the achievement of a better world. A seamless and fair world where everybody wins. A world where People have power.

To sum up, in the ecosystem according to the invention:

People change the way they relation themselves with society and their purchasing, searching and helping behaviors.

Brands change the way they relation themselves with society and their management, marketing and communication behaviors.

Causes change the way they relation themselves with society and their management, marketing, communication and fund raising behaviors.

### VANTAGES OF THE INVENTION

### Regarding Brands:

Brands are able to establish a online, offline, above and below the line, ecosystem with seamless bidirectional interactions with actual and potential clients, and Causes offering ITS Data Offers, Communication and Content (creating value), in order to be able to precisely define, their:
Consumer Real Profile (CRP) and know their demographic, psychographic, relationship, redemption purchasing profile.
Consumer Social Profile (CSP), establishing links with their social online profiles.
Citizenship profile and Causes they support.
Professional Profile, establishing links with their professional online profiles.

This knowledge allows Brands to, at the right time and moment:

1. Offer right product, offer, promotion (bundling, upselling and cross selling) and message most suitable to their actual or potential needs; in the correct channel, in a non-intrusive way, assuring exclusivity treatment, without putting in cause the Brand distribution channel policies.

Increasing profits, reputation/Top of mind, Good will, Share of Wallet, Average Revenue per User (ARPU), etc.

This precision is exponentially increased when People voluntarily share their daily attitude and behavior, regarding purchasing, searching and helping behavior.

2. Create value in society, channeled and fueled by each Brand and company, through the issuing of new and improved currency that will be exchanged between Brands People and Causes, creating value for all entities and contributing for a better world.

Brands will issue ITS Data Offers, ITS Data Communications or ITS Data Contents in all their marketing efforts (either online, offline, bellow or above the line) and contact points offering value to People, in exchange of the profitability generated by this redemption (ITS Data).

The ITS Data Offers, ITS Data Communications or ITS Data Contents are:
Interactive (dynamically, collects and issues)
Traceable (accountable)
Sharable (between issuer and receiver)

The value offered by Brands will be determined by the individual competition of all competing Brands by the actual or potential client's attention, data and preference.

This is the agreed value created by Brands, People and Causes, that Brands and Causes issue and People redeem or not.

Brands may reward client's affiliations according with offline and online transactions, during a certain period of time or in certain number of interactions in any part of the world without any middleware software and Internet connection. Whether the affiliation is started in an online or offline session, the link and the connection is always traced by the owner of the affiliation program and by the affiliate receptor.

Brands may collect and emit personalized information in internal and external company value chain (e.g.: Michael Porter) integrating horizontally and vertically in real time all departments, Physical, Financial and human resources, measuring productivity, efficiency, goal achieving, allowing corrective actions in real time and awarding prizes, rewards and remuneration to their network distribution and their collaborators.

The invention provides the building of gradual, non-intrusive bilateral relationship, with potential and actual clients, with full respect for customers privacy data, that is progressively provided by the conquered customer by the company, while offering the right value for their preference through interactive offers, with the right message, advertising, promotional offers, correct channels and timing, in order to gain advantages and profits with the decrease of management and marketing metrics, like (acquisition cost), Retain Customers (Cost loyalty), Reduce Churn, Communication and Marketing Costs, Productivity and Efficiency Gains, logistic Costs, Etc. . . .

The invention enables Brands to analyze the consumer buying behavior, redemption profile, purchasing interests, Causes interests, etc. with their consent. The win-win relationship promotes their adhesion to marketing permission.

The fact that each one of the interactive offers has a unit cost, a bi-directional relationship (online and offline) with customers and the fact that resources allocated to the redemption offer are traceable, allows Brands to redefine the Pricing Product Model, Promotion Tactics and Sales' Points, differentiating them from competitors, allows Brands to measure their performance in real time and to establish a different interactive connection with consumers (actual and potential consumers).

The collection of traceable online and offline information allows a disruption on several industries, including advertising, printing, publishing, media, logistics, distribution, etc

### Regarding People:

People have power to negotiate with Brands and to make donations to Causes.

### Regarding Causes:

Causes have power, because are a preferential gateway for Brands reach People.

Causes are a close part of People's life, purpose and meaning.

### BRIEF DESCRIPTION OF THE DRAWINGS

For an improved understanding of the invention, drawings are enclosed hereto, which illustrate preferential embodiments of the invention not aiming however to limit the scope of the present invention.

FIGS. 1 and 2: Schematic representation (non-inclusive or mandatory) of the cycle for product and/or content purchase and/or offering, with or without a social responsibility parameter, offer rendering, identification and registration before the system, customized additional-value proposal.

FIGS. 3 and 4: Schematic representation (non-inclusive or mandatory) of the information centrally registered and processed by the system of the present invention.

FIGS. 5 and 6: Schematic representation (non-inclusive or mandatory) of the associated partners and respective information exchange based on the system of the present invention.

FIG. 7: is a schematic representation of Processing Information in a Mobile (Ecosystem)

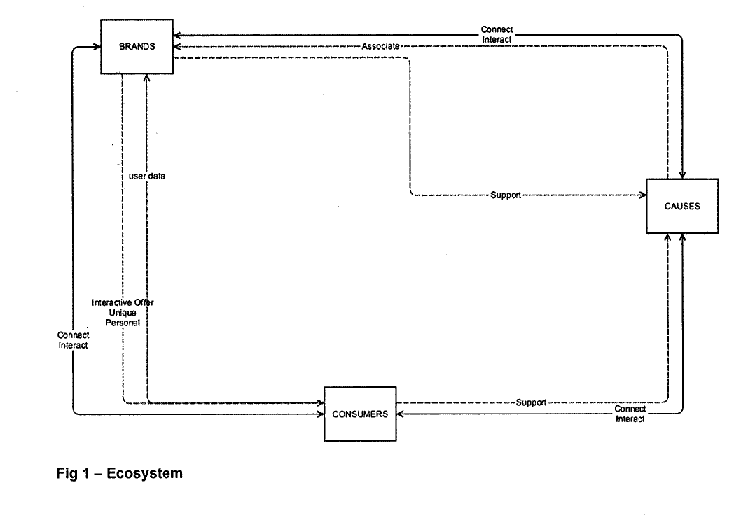

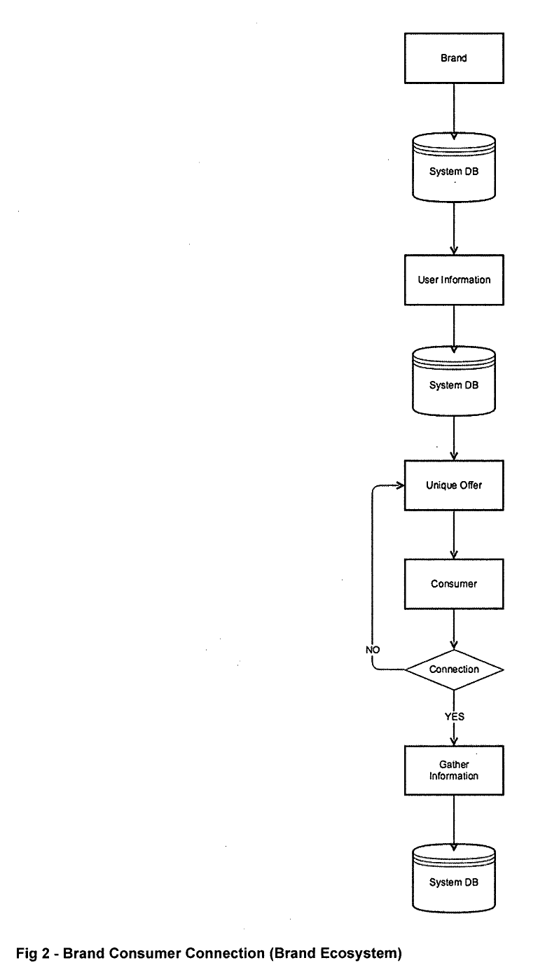

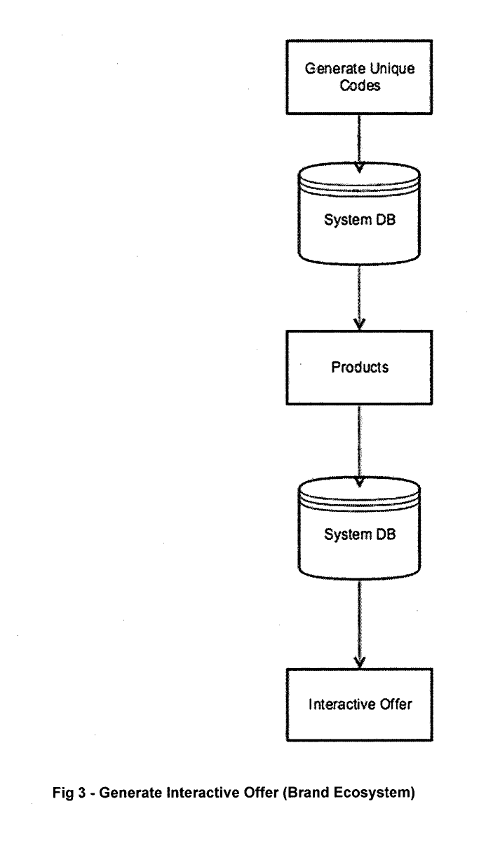

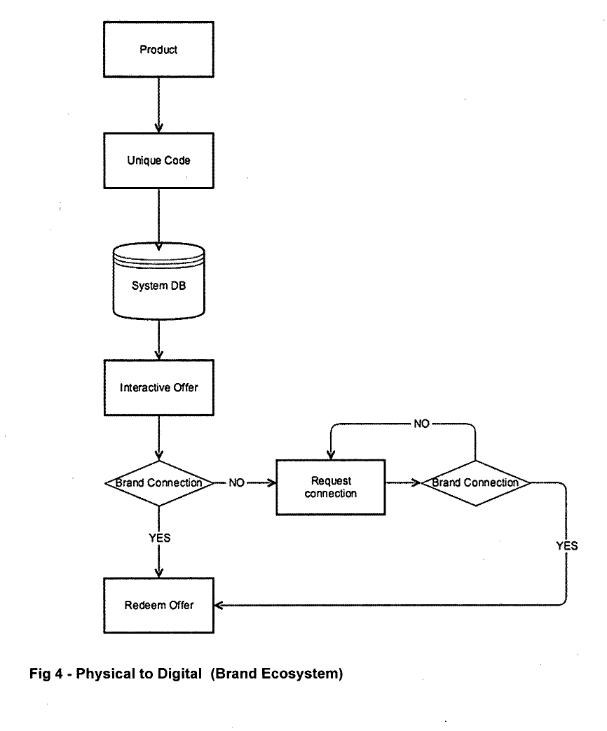

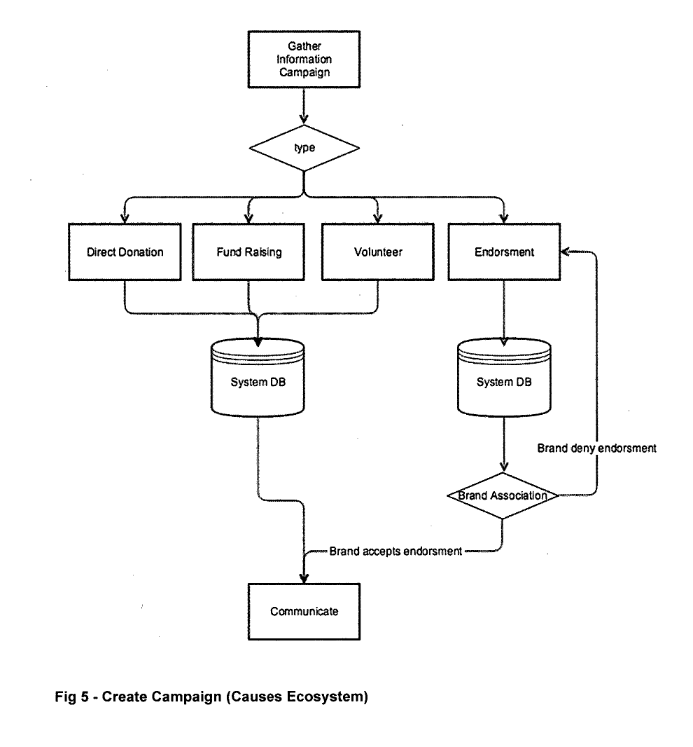

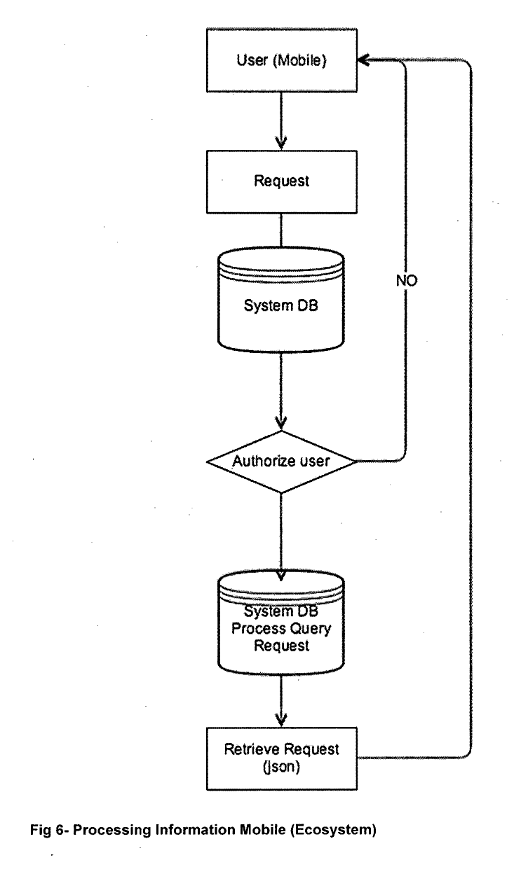

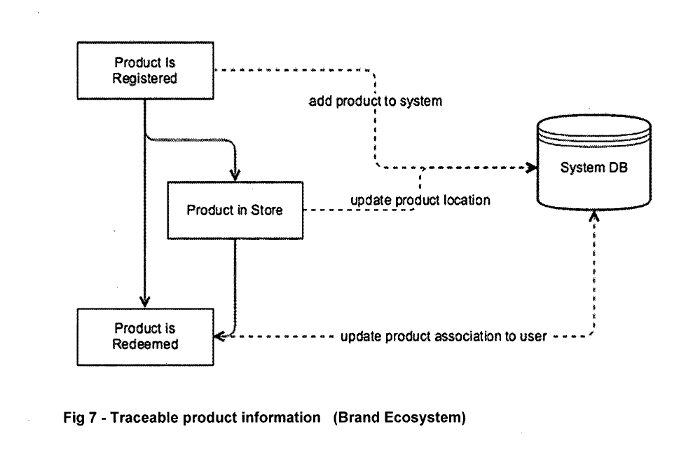

### DETAILED DESCRIPTION OF THE INVENTION

The present invention provides an online and offline ecosystem, where Brands, People and Causes create (ITS Data) and exchange value through a method comprising

a) A central database managed by one or more servers, comprising:

1. Ecosystem central database.

2. Brand database (by Brand, subdivided by value chain elements (Michael Porter, primary and support activities, Internal and External to the company)

3. People database (by individual person).

4. Causes database (Michael Porter, primary and support activities, Internal and External to the company)

b) Ecosystem API Application Programming Interface that provides the integration of the data with Brands and Causes Legacy Systems: Information Management Systems, Customer Relationship Management, Payment Systems, Loyalty Programs, Logistic Software, Point of Sales Software, Etc.

c) A back offices for Brands to generate in the ecosystem a virtual individual, unique and unrepeatable serial sequential code that will identify solely a product item in the Brands central database, and the corresponding unique variable interactive offer.

A Product Items, can be:
A Company Product, to be sold to actual clients (physical pixel), e.g.: a mobile phone
A Offer, to be given to a actual or potential clients (Physical pixel), e.g.: a backpack (a gift item) with a offer card with the physical pixel
Interaction Offers, to be given to actual or potential clients (Physical pixel) in qualified interactions (pre and post interaction qualification, through a back office), e.g.: After a sales meeting.

Between a sales rep and client, the sales rep offers an offer card with physical pixel. The sales rep is able through certain rules to change the pre-qualification of the client and the communication and offer to issue in the ecosystem to the client.
Content offers, to be issued/given to actual potential clients (Physical pixel) in physical communication mediums (Newspaper, Magazines, Etc. . . . , e.g.: Each magazine has physical pixel with an offer for actual and potential clients.
Digital Content offers, to be issued/given to actual or potential clients (Digital pixel) in digital communication mediums (web site, Blog, social network communications, etc.)

E.g.: Each digital publication has a digital pixel with a pre-qualification of the information to collect and issue to actual or potential clients.

This digital pixel, can share pre-qualified information with third parties medium entities, if agreed (e.g. Other Brands, Bloggers, etc.)
Above the Line Content messages or offers to be issued/given to actual or potential clients (Digital pixel) in above the line mediums (TV, Radios, etc., etc.)

d) Brands individual back offices for each one of their value chain (e.g.: Michael porter) activities support (administration, purchasing, human resources, information technologies, etc.) and primary activities (logistic, operations, marketing, commercial, after sales) enabling them to manage, market and attach to each product time a individual ITS Data, just before the product items is shipped, issued or turned available to their actual and potential clients:
1. A pre-qualification of the information to collect and to issue

E.g.: The marketing department defines what would be the information collected and issued in the product X sold to the external distributor Y.
2. A post qualification of the information to collect and to issue

E.g.: The sales rep of a company, according with the limits defined by the company, changes the information that will be collected and issued in a offer card given by the company.
3. Information to trace: Investment, Resources allocated to future redemption
4. Shareable data

e) Brands back offices for Brands to automatically attach to each product item (operations department) a physical or digital pixel, according to the date, company goals, destination or medium in which the product item will be sold, given or issued/advertised.

E.g.: A unique offer code generated by the Brand is attached to a company product and a pre-qualification of the information to collect and to issue is attached according to the date, company and destination where to product will be sold (re-seller).

In the exact time the item is shipped, when a delivery note is issued, for each delivery note and physical pixels read by a bar code scanner or other methods, it is attached a pre-qualification of the information to collect and to issue.

### 1. Regarding Products and Offers:

e.g.: a unique physical pixel is attached each one company product and offer and a range of pixels is attached to a company delivery note after reading each individual pixel automatically by a pistol code machine or other method, this integrations is achieved with a integration between operations and logistic software of the company and ecosystem back office of the company (Logistic, administration and marketing).

2. Regarding Interactions, with a physical offer:

e.g.: Same as for company product and offers, but with integration with the point of sales and company or external partner employee.

### 3. Regarding Content Offer:

e.g.: a unique physical pixel is supplied to the medium attached each to each copy of the physical content offered to actual and potential clients.

This integration is achieved with a integration between ecosystem back office of the company (administration, marketing, logistics when needed).

### 4. Regarding Digital Content Offer:

e.g.: a unique digital pixel is attached to each content available for actual and potential clients, each one of them with a prequalification attached

### 5. Regarding Above the Line Digital Content Offer:

E.g. A unique voice or video file is signalled has unique identifier in the Brands ecosystem back office.

To this unique identifier is attached pre-qualified information to collect, issue, trace and share, between Brands, People and Causes when the voice or video file is recognized and redeemed by People, for instance via a smartphone, computer, TV or other using technologies like voice recognition, Image Recognition, or others.

With a attached pre-qualification of:
The data to collect
Communication or offers to issue
Information to trace
Information to share

Defined in real time by the Brands (Ex. Marketing Department, Administration, Logistics, Information Technologies, Point of Sales or others).

Brands can pre-qualify the information to be collected, when the redemption by the part of the actual or potential client occurs, according with several parameters, e.g.: Demographic, psychograph and relational profile, consumer life time value, clients name, etc.

Brands at the same make the same pre-qualification of the information actual and potential clients will see when access the online ecosystem (interactive offer, publicity or promotional offer).

This will allow Brands to maximize their value and profitability,

This information can be changed at any time by the Brands, according with new company specifications or partnerships established.

The information to issue can be changed if the company already knows the person who redeems de offer and the connection of the information pre-qualified and the existing data gives qualify a different profile and information to issues.

All the internal and external company value chain activities, may have internal back office, either to make necessary operations and or to make changes in the pre qualifications of the information to collect and to issue, always, according with the rules and authorisations defined by the company administration.

f) Brands back office for Brands to make an interconnection between the Physical flow and Virtual Flow, by attaching through their back offices, the individual products item (Range) to unique IST Data (Range), just before they are shipped or issued, to their actual or potential clients.

g) Redemption of the ITS Data by actual or potential clients in the Brands online personalized back office.

All the individual codes are redeemed by the actual or potential client, after giving permission for the Brands to data mine their data, in the Brands online ecosystem place.

h) Personal online back office for People to manage all their interactions, offers, etc.

All the registration of personal data of the client is made in the central database and includes permission marketing.

i) Back offices for Brands to manage, interconnect, qualify and make the tracking of the information collected during all individual item transactions, gifts and interactions throughout the value chain of the company without the need of collaboration of third parties, namely wholesalers, retailers or distributors.

Each Brand has several back offices which integrates all the value chain activities (primary and support, internal and external), where they can make the interconnection and manage their company and maximize profits (as described before).

Support activities: administration, purchasing, human resources, etc.

Primary activities: logistic, operations, marketing, commercial, after sales.

Internal Value Chain Activities are those made by Brand own resources.

External Value Chain Activities are those made by external resources with the resource of established partnerships.

The physical and digital pixel allocation and pre-qualification can be made through the integration of all value chain of Brands, from logistics, operations, expedition, marketing to after sales and made in the exact time and moment in which a physical or communication flow is send and previewed to the actual or potential clients, as described before.

j) Back offices for Brands to make the conversion of individual transactions, redemptions, and data into a customized purchase patterns, redemption partners, clients patterns, etc.

Brands are able, through the data mining of the information given by the actual and potential clients, either in transaction, data interaction exchange, offers redemption, content seen and others, to know:
Exact profile of the client (Consumer Real Profile)
What is their place in sales funnel
Consumer Life time value
Pattern purchase
Etc.

The method of the invention is adapted to motivate the insertion of the code by means of awarding the consumer with an interactive offer, adapted according to pre-established rules of the company.

The interactive offer is unique, exclusive, one time used and limited to the codes issued by the company according to pre-established rules, each code having a unit value and being offered to company's actual consumers and potential customers in their different touch points (communication in several media platforms and distribution channels) after consumer having validated such code, giving the required data and allowing permission marketing.

In a further embodiment, the method of the invention allows the consumer with the possibility to assign monetary and/or service contributions to charities of its choice, with origin in their own pocket and or within the partnership established in the technological platform between Brands and consumers.

Each donation can be tracked, with a relation cause effect, controlled in the technological platform, begin in the online or offline world, virtualized, multiplied and materialized without requiring middleware, software and hardware or real time connection internet.

With the present invention, fund raising activities can have origin in every corner and point of sale in the world has it does not needs the collaboration of the distribution channels or Internet.

The donor may retain the information from private contribution or he can share it in social networks (Facebook, Google plus, twitter, etc. . . . ) automatically improving his virtual image.

1. A system for the registration, compensation, management and analysis of product items or content customized purchase or selling items comprising:
a) an online and offline ecosystem database to be used by Brands, People and Causes and managed by one or more servers;
b) an internal back office for the Brand to generate in the ecosystem database a virtual individual, unique and unrepeatable serial sequential code that will identify solely a product item in the Brands central database, and the corresponding unique variable interactive offer;
c) internal back offices for the Brand to make a pre-qualification of said code according to the destination of the item, the information to be collected (demographic, psychographic and relational profile and consumer life time value, clients name), the information to be issued (interactive offer, publicity or promotional offer), the information to trace and the information to share;
d) internal back offices for the Brand to attach to each product item said code encompassing the above mentioned pre-qualification before the product item is shipped, issued or turned available to the Brand actual and potential clients;
e) an internal back office for the Brand to make an interconnection between the physical flow of the item and the virtual flow of the information collected and issued according to the pre-qualification;
f) an online personalized back office for the redemption of said code by the Brand actual or potential client, after registering their personal data and giving permission for the Brand to data mine their data;
g) internal back offices for the Brand to manage, interconnect, qualify and make the tracking of the information collected during all individual item transactions throughout the value chain of the company without the need of collaboration of third parties, namely wholesalers, retailers or distributors;
h) internal back offices for Brands to make the conversion of individual transactions, redemptions and collected data into a customized purchase pattern.

2. A system according to claim 1 wherein the online and offline ecosystem database comprises:
A central database;
A Brand database, subdivided by each value chain entity;
A People database (by individual person);
A Causes database (by individual institution);
An Application Programming Interface (API) that provides the integration of the data between Brand, People and Causes.
Information Management Systems, Customer Relationship Management Systems, Payment Systems, Loyalty Programs, Logistic Software and Point of Sales Software.

3. A system according to claim 1 wherein the individual, unique and unrepeatable serial sequential code comprises a bar code and a random numeric code.

4. A system according to claim 1 wherein the unique serial sequential code is individually incorporated into each item by means of:
a) Inserting a serial card, either in physical or digital format or,
b) Printing onto the physical support of the item a serial number, either in physical or digital format.

5. A system according to claim 1 wherein the redemption of the code is motivated by means of awarding the actual and potential client with a prize, compensation or association, in particular experiences, offers, prices and individual discounts.

6. A system according to claim 1 wherein the redemption of the Code and the rendering of the offer by the Brand actual and potential client is made by means of:
a) technological platforms, in particular Web, Wap, SMS, telephone, Bluetooth, Wi-Fi, RF, RF-ID, or
b) presentation at the sales outlet of physical support showing written or engraved said code, or
c) specific places and/or events wherein the said offers will be available for rendering.

7. A system according to claim 1 wherein the pre-qualification of the code can be made by each value chain entity of the Brand at any time prior or after the redemption of the offer by the actual or potential client according to the date, goals, destination or medium in which the product item will be sold, given, issued or advertised.

8. A system according to claim 1 wherein the pre-qualification of the code can be changed at any time by each value chain entity of the Brand according to the date, goals, destination or medium in which the product item will be sold, given, issued or advertised.

9. A system according to claim 1 comprising additionally a back office to allow the consumer to assign monetary and/or service contributions to Causes (charities) of its choice, the value of the contribution being set by the consumer among several values and selections which are defined by the entity offering said values.
